(19) United States
(12) Patent Application Publication
(10) Pub. No.: US 2006/0177129 A1
(43) Pub. Date: Aug. 10, 2006

(54) Color signal processing method

(75) Inventor: Hisashi Matsuyama, Ogaki-shi (JP)

Correspondence Address: OLIFF & BERRIDGE, PLC, P.O. BOX 19928, ALEXANDRIA, VA, 22320, US

(73) Assignee: SANYO ELECTRIC CO., LTD., Moriguchi-shi (JP)

(21) Appl. No.: 11/345,405

(22) Filed: Feb. 2, 2006

(30) Foreign Application Priority Data
Feb. 7, 2005 (JP) 2005-029979

(51) Int. Cl. G06K 9/00; G06K 9/40

(52) U.S. Cl. 382/167; 382/274

(57) ABSTRACT

When respective color filters in respective light receiving elements of RGB allow transmission of infrared light, respective signal components due to infrared light (IR components) overlap color signals. To avoid disruption of color balance due to this, first, the IR components Ir, Ig, Ib contained in respective color signals of RGB are specified based on an output signal from an IR light receiving element that detects an IR component. Next, respective color signals are corrected such that the ratio of the IR components contained in respective color signals corresponds to the ratio of components of RGB in white light, so that correction color signals are generated.

### PRIORITY INFORMATION

This application claims priority to Japanese Patent Application No. 2005-029979 which is incorporated herein by reference in its entirety.

### BACKGROUND OF THE INVENTION

1. Field of the Invention

The present invention relates to a processing method of color signals obtained from several types of light receiving elements for detecting color components different from one another, and particularly relates to correction processing to deal with an offset component associated with a non-targeted wavelength contained in respective color signals.

2. Description of Related Art

A solid-state image pickup device such as CCD (Charge Coupled Device) image sensor mounted in a video camera or a digital camera has light receiving elements in a two-dimensional array, and performs photoelectric conversion to incident light to generate an electric image signal using the light receiving elements. The light receiving element includes a photodiode formed on a semiconductor substrate, and the photodiode itself has a common spectral sensitivity characteristic of all light receiving elements. Therefore, several types of color filters having different colors of transmitted light or different ranges of transmitted wavelengths are disposed on the photodiode.

The color filters include a primary-color filter set having colors of transmitted light of red (R), green (G), and blue (B), and a complementary-color filter set having those of cyan (Cy), magenta (Mg) and yellow (Ye). The color filters are formed, for example, from colored organic materials. Due to a property of the material, the color filters transmit not only visible light of corresponding colors respectively but also infra-red light. For example, FIG. 1 is a graph showing wavelength characteristics of transmittance of respective filters of RGB. FIG. 1 shows also a spectral sensitivity characteristic of a photodiode. While the color filters of respective colors exhibit specific spectral characteristics in transmittance corresponding to respective colors in a visible light region, they exhibit approximately common spectral characteristics in an infra-red light domain.

On the other hand, the photodiode has sensitivity to all the visible light region in a wavelength range of about 380 to 780 nm, in addition, has sensitivity to the near-infrared region in the longer wavelength range. Therefore, when an infrared light component (IR component) comes to the light receiving element, that infrared light component is transmitted through the color filter, and causes signal charges in the photodiode, consequently correct color expression may be hindered. Thus, an infrared cut filter has been separately disposed between a lens of a camera and the solid-state image pickup device.

The infrared cut filer cuts infrared light, and attenuates visible light about 10 to 20% at the same time. Therefore, there has been a problem that intensity of visible light injected to the light receiving element is decreased, and the S/N ratio of an output signal is reduced along with that, causing deterioration in image quality.

As a solution of the problem, a solid-state image pickup device is proposed in patent literature 1 described below. While the infrared cut filter is eliminated from the proposed device, the proposed device has a light receiving element (IR light receiving element) that essentially detects only the IR component in incident light in addition to the light receiving elements (specific color light receiving elements) having color filters that transmit light components of specific colors such as RGB. A signal outputted by the IR light receiving element (reference signal) gives information on a level of a signal generated due to the IR component in each of the light receiving elements. In the literature, it is considered that the reference signal may be used to remove influence of the IR component contained in each color signal outputted from the specific color light receiving element.

The IR light receiving element can be realized by stacking several types of color filters that transmit visible light of colors different from one another on the photodiode. That is, while the color filters stacked on one another blocks transmission of visible light by having a visible light component transmitted through one color filter absorbed by the other color filters, respective color filters transmit the IR component, as a result the color filters selectively transmit infrared light.

A color signal processing method in the related art is described, in which RGB signals, or a luminance signal Y and color difference signals Cr, Cb are generated, for example, based on an output signal from a solid-state image pickup device in which the R light receiving element, G light receiving element, and B light receiving element having specific sensitivity to R, G, and B components of the incident light respectively, and the IR light receiving element selectively having sensitivity to infrared light are two-dimensionally arrayed in an image pickup portion.

FIG. 2 is a graph showing spectral sensitivity characteristics of respective light receiving elements of RGB. The spectral sensitivity characteristics of respective light receiving elements of RGB are products of transmittance characteristics of respective filters of R, G and B with the spectral sensitivity characteristic of the photodiode as shown in FIG. 1. Respective light receiving elements commonly have strong sensitivity in the infrared light region that is a wavelength range of more than 780 nm, and on the other hand, exhibit strong sensitivity in specific wavelength ranges in accordance with transmittance characteristics of filters disposed in respective elements. Specifically, in FIG. 2, a spectral sensitivity characteristic 30 of the G light receiving element includes overlapped peaks of a peak 32 having a center near 550 nm corresponding to green as a spectral sensitivity characteristic specific to that light receiving element, and a peak 34 having a center near 850 nm in the infrared region. Similarly, a spectral sensitivity characteristic 40 of the B light receiving element includes overlapped peaks of a peak 42 having a center near 450 nm corresponding to blue as a spectral sensitivity characteristic specific to that light receiving element, and a peak 44 having a center near 850 nm in the infrared region. In a spectral sensitivity characteristic 50 of the R light receiving element, while two separated peaks do not appear because red and infrared regions are adjacent to each other, it can be still seen from FIG. 2 that an emphasized sensitivity portion 52 near 650 nm corresponding to red and an emphasized sensitivity portion 54 in the infrared region are overlapped.

Generally, the luminance signal Y is expressed by a primary formula of respective RGB components as shown below using appropriate coefficients α, β and γ.
Y=αR+βG+γB (1)

Here, the following relation is given:
α+β+γ=1.

General formulas of the color difference signals Cr and Cb are expressed by the following formulas using coefficients λ and μ.
Cr=≡λ(R−Y) (2)
Cb=≡μ(B−Y) (3)

When [symbol] R [symbol] , [symbol] G [symbol] and [symbol] B [symbol] denote output signals of the R light receiving element, G light receiving element, and B light receiving element, respectively, R₀, G₀ and B₀ denote signal components in response to R, G and B components of incident light in the output signals, respectively, and Ir, Ig and Ib denote signal components in response to infrared light in the output signals, respectively, the following formulas are established. [symbol]
R [symbol] =R₀+Ir [symbol]
G [symbol] =G₀+Ig (4) [symbol]
B [symbol] =B₀+Ib

In FIG. 2, the R₀, G₀ and B₀ are signal components generated corresponding to portions in correspondence with the emphasized part 52 and the peaks 32, 42 in the spectral sensitivity characteristics respectively; and the Ir, Ig and Ib are signal components generated corresponding to the emphasized part 54 and the peaks 34, 44 in the spectral sensitivity characteristics respectively.

Here, the output signal of the IR light receiving element is indicated by [symbol] IR [symbol] . The color filters disposed in respective light receiving elements of R, G, B and IR have essentially similar spectral characteristics in the infrared light region, and consequently Ir, Ig, Ib and [symbol] IR [symbol] are in approximately the same level. When the following relation
Ir=Ig=Ib= [symbol] IR [symbol] (5)
is assumed for simplification of description,
the formulas (4) are expressed as follows. [symbol]
R [symbol] =R₀+ [symbol] IR [symbol] [symbol]
G [symbol] =G₀+ [symbol] IR [symbol] (6) [symbol]
B [symbol] =B₀+ [symbol] IR

[symbol]

The [symbol] R [symbol] , [symbol] G [symbol] and [symbol] B [symbol] expressed by the formulas (4) or the formulas (6) include IR components as offsets that have approximately the same level respectively, and therefore an image expressed by them is disrupted in color balance. Particularly, if the IR components are larger compared with the R₀, G₀ and B₀, the balance is disrupted more significantly. Similarly, a luminance signal Y′ and color difference signals Cr′, Cb′ obtained from the formulas (1) to (3) using the [symbol] R [symbol] , [symbol] G [symbol] and [symbol] B [symbol] cause an image that is expressed out of color balance.

Thus, in the processing method in the related art, it has been performed that the R₀, G₀ and B₀ are outputted with the IR components being removed, or a luminance signal Y₀ and color difference signals Cr₀, Cb₀ obtained from the formulas (1) to (3) are generated according to the R₀, G₀ and B₀.

Specifically, the R₀, G₀ and B₀ can be calculated by the following formulas using output from respective light receiving elements of R, G, B and IR.
R₀= [symbol] R [symbol] − [symbol] IR [symbol]
G₀= [symbol] G [symbol] − [symbol] IR [symbol] (7)
B₀= [symbol] B [symbol] − [symbol] IR

[symbol]

The luminance signal Y₀ can be calculated by the following formula based on the output signals of respective light receiving elements.
Y₀=α [symbol] R [symbol] +β [symbol] G [symbol] +γ [symbol] B [symbol] − [symbol] IR [symbol] (8)

The color difference signals Cr₀, Cb₀ can be calculated by the following formulas.

$$\begin{matrix}\begin{matrix}{Cr}_{0} ≡ λ ( {R}_{0} - {Y}_{0} ) \\ = λ \{ ( 1 –α ) 〈 R 〉 - β 〈 G 〉 - γ 〈 B 〉 \}\end{matrix} & \begin{matrix}( 9 ) \\ ( {9}^{′} )\end{matrix} \\ \begin{matrix}{Cb}_{0} ≡ μ ( {B}_{0} - {Y}_{0} ) \\ = μ \{ - α 〈 R 〉 - β 〈 G 〉 + ( 1 - γ ) 〈 B 〉 \}\end{matrix} & \begin{matrix}( 10 ) \\ ( {10}^{′} )\end{matrix}\end{matrix}$$

For example, α, β and γ can be set as follows.

α=0.299, β=0.587, and γ=0.114.

λ and μ can be set such that a coefficient (1−α) of an R component contained in Cr₀ and a coefficient (1−γ) of a B component contained in Cb₀ are scaled to 0.5 respectively, and the following values are given for the above values of α, β and γ.

λ=0.713 and μ=0.564.

Principally, if the IR components are removed as described above, R, G and B signals or Y, Cr and Cb signals that enable correct expression of color balance must be obtained. However, when light injected to respective light receiving elements contains a large IR component, for example, a case of photographing under illumination using an incandescent lamp, the output signal [symbol] IR [symbol] from the IR light receiving element is increased, and the IR components Ir, Ig and Ib contained in the output signals [symbol] R [symbol] , [symbol] G [symbol] and [symbol] B [symbol] from respective light receiving elements of RGB are also increased.

The signal processing according to the formulas (7) or the formulas (8) to (10) is performed using digital data obtained by A/D (Analog to Digital) conversion of an analogue signal outputted from the solid-state image pickup device. In the A/D conversion, the analogue signal is converted into digital data having a certain bit number. For example, when a quantization bit number in the A/D conversion is 8 bits, the output signals [symbol] R [symbol] , [symbol] G [symbol] , [symbol] B [symbol] and [symbol] IR [symbol] from respective light receiving elements are expressed by integral values within a range of 0 to 255.

In such an output signal after A/D conversion, as the IR components are increased, the R₀, G₀ and B₀ that are original RGB components are relatively decreased. Therefore, Y₀ is decreased corresponding to decrease in R₀, G₀ and B₀, and a problem of darkening of an image occurs as can be understood from this.

When R₀, G₀ and B₀ expressed in digital data are obtained from [symbol] R [symbol] , [symbol] G [symbol] , [symbol] B [symbol] and [symbol] IR [symbol] expressed in digital data, for example, using the formulas (7), obtained R₀, G₀ and B₀ may include rounding errors associated with quantization. The rounding errors in the R₀, G₀ and B₀ are relatively increased when R₀, G₀ and B₀ are smaller. Therefore, there has been a further problem that a color expressed by the R₀, G₀ and B₀ obtained with the IR components being removed, or the Cr and Cb obtained from them may have comparatively large deviation in color balance due to influence of the rounding errors.

[Patent literature 1]

JP-A-2005-184690.

### SUMMARY OF THE INVENTION

The invention provides a color signal processing method which gives an image that is correct in color balance and bright, when color signals obtained from several types of light receiving elements for detecting color components different from one another contain offset components related to a wavelength not targeted, such as the IR components.

The invention relates to a color signal processing method which uses a reference signal obtained from a light receiving element having a certain reference spectral sensitivity characteristic, and several types of color signals obtained from several types of light receiving elements having spectral sensitivity characteristics, each of which is a synthesis of a specific sensitivity characteristic corresponding to each of specific colors different from one another and an offset sensitivity characteristic corresponding to the reference spectral sensitivity characteristic. The color signal processing method according to the invention has a correction step of determining an offset signal component level in accordance with the offset sensitivity characteristic based on the reference signal contained in each of the color signals, and changing the ratio of the offset signal component levels among the color signals, thereby generating respective correction color signals from each of the color signals; wherein the ratio of the offset signal component levels among the correction color signals is determined according to the component ratio of each of the specific colors in white light.

Another color signal processing method according to the invention has a correction color difference signal generation step of generating a correction color difference signal in accordance with correction color signals from the several types of color signal. Here, in the correction color signals the ratio of the offset signal component level, which is in accordance with the offset sensitivity characteristic, among the color signals has been changed. The ratio of the offset signal component level among the correction color signals is determined according to a component ratio of each of the specific colors in white light.

### BRIEF DESCRIPTION OF THE DRAWINGS

FIG. 1 is a graph showing wavelength characteristics of transmittance of respective filters of RGB, and a spectral sensitivity characteristic of a photodiode;

FIG. 2 is a graph showing spectral sensitivity characteristics of respective light receiving elements of RGB; and

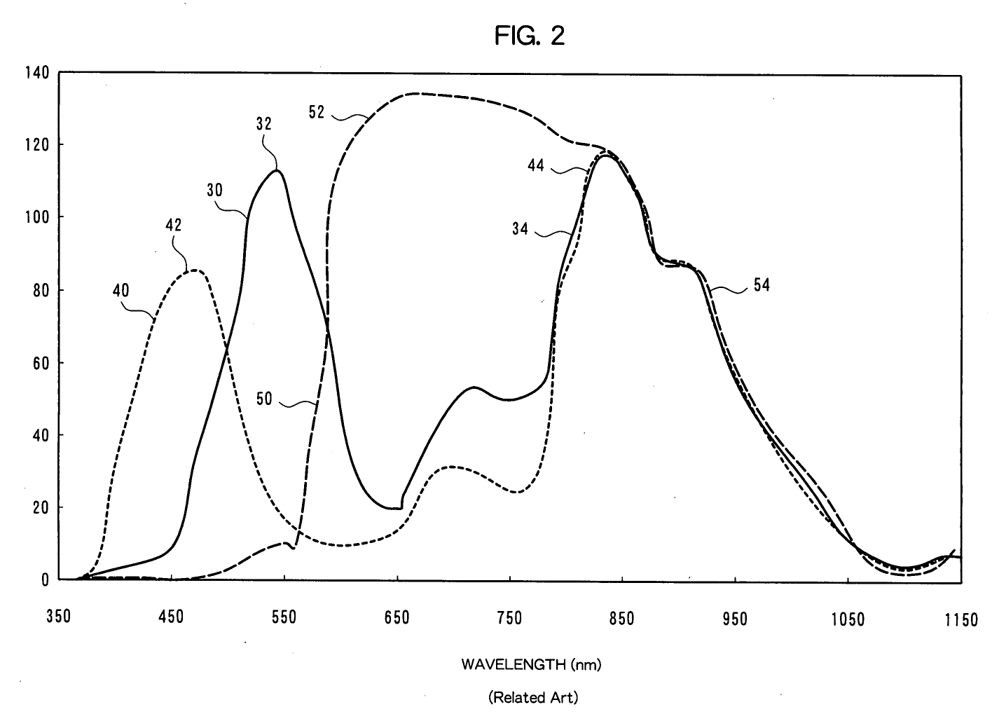

FIG. 3 is a block diagram showing a general configuration of an image pickup device according to an embodiment.

### DESCRIPTION OF THE PREFERRED EMBODIMENT

Hereinafter, an embodiment of the invention (hereinafter, referred to as embodiment) will be described according to drawings.

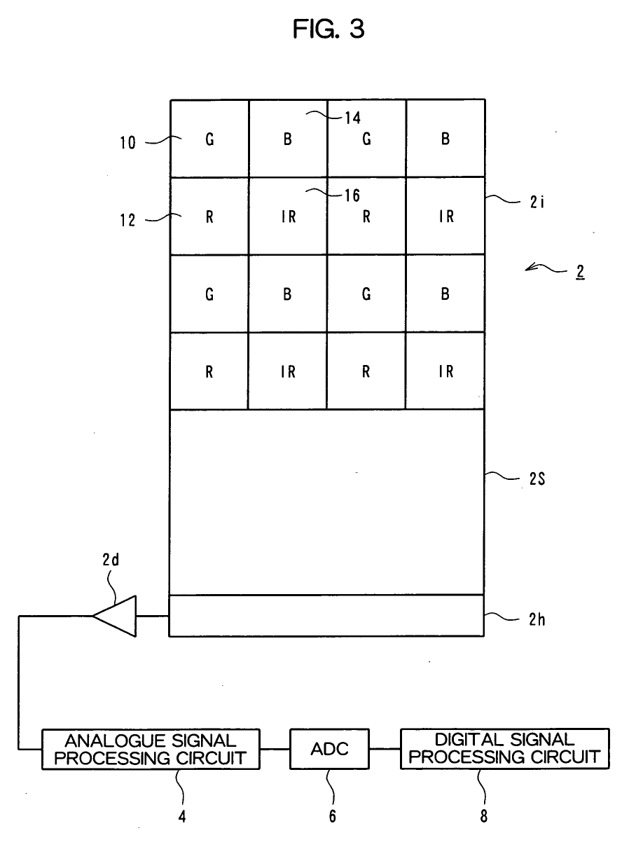

FIG. 3 is a block diagram showing a general configuration of an image pickup device according to the embodiment. The image pickup device has a CCD image sensor 2, an analogue signal processing circuit 4, A/D conversion circuit (ADC) 6 and a digital signal processing circuit 8.

The CCD image sensor 2 shown in FIG. 3 is in a frame transfer type, and configured to include an image pickup portion 2i, a storage portion 2s, a horizontal transfer portion 2h, and an output portion 2d.

Respective bits of a vertical shift register forming the image pickup portion 2i act as light receiving elements that form pixels respectively.

Each of light receiving elements has a color filter disposed therein, and a light component to which the light receiving element has sensitivity is determined according to a transmission characteristic of the color filter. Here, an array of 2-by-2 pixels configures a unit of arrays of the light receiving elements. For example, light receiving elements 10, 12, 14 and 16 configure the unit.

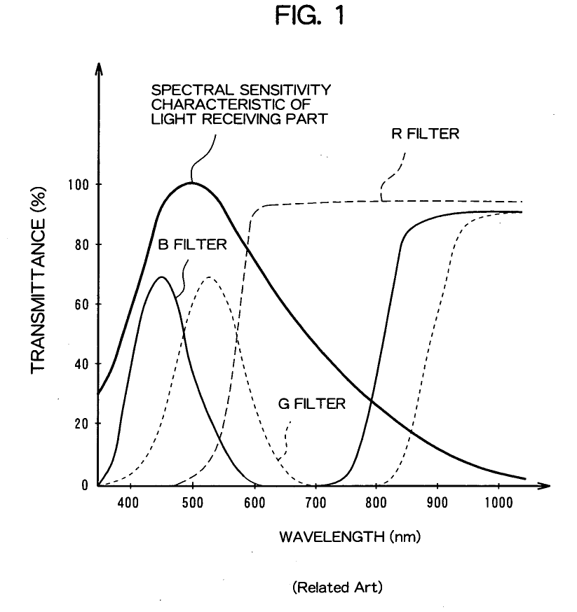

In the light receiving elements 10, 12 and 14, a G filter, an R filter and a B filter are disposed respectively. Each of the filters has a transmission characteristic, for example, as shown in FIG. 1. The light receiving element 10 represents a G light receiving element. That light receiving element generates signal charges in correspondence with a G component and the IR component in response to incident light containing not only visible light but also the IR component. Similarly, the light receiving element 12 represents an R light receiving element that generates signal charges in correspondence with an R component and the IR component; and the light receiving element 14 represents a B light receiving element that generates signal charges in correspondence with a B component and the IR component.

The light receiving element 16, in which an IR filter (infrared light transmission filter) that selectively transmits the IR component is disposed, is an IR light receiving element that generates signal charges in correspondence with the IR component in the incident light. The IR filter can be configured by stacking the R filter and the B filter. Because, among visible light, the B component transmitted through the B filter is not transmitted through the R filter, and on the other hand, the R component transmitted through the R filter is not transmitted through the B filter, therefore visible light components are essentially removed by transmitting the light through both filters, and the IR component that can be transmitted through both filters is solely remained in transmitted light.

In the image pickup portion 2i, the 2-by-2 pixel configurations are arrayed repeatedly in vertical and horizontal directions respectively.

The CCD image sensor 2 is driven by a clock pulse and the like supplied from a not-shown drive circuit, and the signal charges generated in respective light receiving elements in the image pickup portion 2i are transferred to the output portion 2d via the storage portion 2s and the horizontal transfer portion 2h. The output portion 2d converts the signal charges outputted from the horizontal transfer portion 2h into a voltage signal, and outputs it as an image signal.

The analogue signal processing circuit 4 performs processing such as amplification or sample-and-hold to the image signal as analogue signal outputted by the output portion 2d. The A/D conversion circuit 6 converts the image signal outputted from the analogue signal processing circuit 4 into digital data having a certain quantization bit number, thereby generates image data, and then outputs them. For example, the A/D conversion circuit 6 performs A/D conversion into 8-bit digital values, and thus image data are expressed by values within a range of 0 to 255.

The digital signal processing circuit 8 loads the image data from the A/D conversion circuit 6, and performs various types of processing to the data. For example, the digital signal processing circuit 8 performs spatial interpolation processing to the image data. Through the interpolation processing, by using image data that selectively provide one of R, G, B and IR data for each of sampling points corresponding to positions of the light receiving elements, image data in which each of R, G, B and IR data is defined at each of the sampling points are generated. Moreover, by using the data, processing of generating luminance data (luminance signal) Y and color difference data (color difference signals) Cr, Cb can be performed at each of the sampling points.

Hereinafter, a color signal processing method for generating Y, Cr and Cb is described. Hereinafter, symbols that were described in the section of the related art are used to the utmost for simplification of description. Signals as input into the color signal processing are [symbol] R [symbol] , [symbol] G [symbol] , [symbol] B [symbol] and [symbol] IR [symbol] which are defined for respective sampling points of an image by spatially interpolating output signals of respective light receiving elements of R, G, B and IR respectively.

As a simple case, a case where the formula (5), that is,
Ir=Ig=Ib= [symbol] IR [symbol]
is true is described. In this case, the following formula that is the same as the formula (6) is established. [symbol]
R [symbol] =R₀+ [symbol] IR [symbol] [symbol]
G [symbol] =G₀+ [symbol] IR [symbol] [symbol]
B [symbol] =B₀ [symbol] IR

[symbol]

The ratio among R, G and B components in white light is as follows.
α:β:γ (11)
In correspondence with this, correction color signals R_{N}, G_{N} and B_{N} expressed by the following formula are defined.
R_{N}=R₀+κα [symbol] IR [symbol]
G_{N}=G₀+κβ [symbol] IR [symbol] (12)
B_{N}=B₀+κγ [symbol] IR

[symbol]

Here, κ is a proportionality coefficient that satisfies κ>0. The color expressed by synthesizing the correction color signals R_{N}, G_{N}, and B_{N} is the color expressed by synthesizing the correction color signals R₀, G₀, and B₀, because synthesis of the IR components contained in respective correction color signals becomes white light. Thus, the color is based on the signal components R₀, G₀, and B₀ which correspond to specific sensitivity characteristics in the visible light region which respective light receiving elements R, G and B intend to detect, and consequently deviation in color balance due to the IR component is avoided.

For example, α, β and γ can be set as follows.
α=0.299, β=0.587, and γ=0.114 (13)
Moreover, for example, κ can be set such that the IR component in the correction color signal G_{N} is equal to IR component in the original color signal [symbol] G [symbol] for the reason that the IR component contained in the G component has the highest ratio in the white light (or luminance signal). In that case, κ is set to 1/β.

According to the formulas (1) and (12), a luminance signal Y_{N} corresponding to the correction color signals is expressed as follows.
Y_{N}=Y₀+κ(α²+β²+γ²) [symbol] IR [symbol] (14)
Here, the following relation is given.
Y₀=αR₀+βG₀+γB₀ (15)
As known from the formula (14), Y_{N} is larger than Y₀. Accordingly, an image based on the correction color signals becomes brighter.

On the other hand, color difference signals Cr_{N}, Cb_{N} corresponding to the correction color signals are defined by the following formulas corresponding to the formulas (2) and (3).
Cr_{N}=λ(R_{N}−Y_{N}) (16)
Cb_{N}=μ(B_{N}−Y_{N}) (17)

When the formulas (16), (17) are expressed using the original color signals [symbol] R [symbol] , [symbol] G [symbol] and [symbol] B [symbol] and a luminance signal Y′ corresponding to them, the following formulas are given.
CR_{N}=λ{ [symbol] R [symbol] −Y′−κ(α²+β²+γ²−α) [symbol] IR [symbol] } (16′)
Cb_{N}=μ{ [symbol] B [symbol] −Y′−κ(α²+β²+γ²−γ) [symbol] IR [symbol] } (17′)
Here, the following relation is given.
Y′≡α [symbol] R [symbol] >+β [symbol] G [symbol] +γ [symbol] B [symbol]
When the formulas (16′) and (17′) are obtained, the formulas (6), (12) and (14) and the following relation are used.
Y′=Y₀+ [symbol] IR [symbol] (18)

When the following formulas expressing color difference signals Cr′, Cb′ corresponding to the original color signals [symbol] R [symbol] , [symbol] G [symbol] and [symbol] B [symbol] ,
Cr′≡λ( [symbol] R [symbol] −Y′) and
Cb≡μ( [symbol] B [symbol] −Y′)
are compared with the formulas (16′) and (17′), the formulas (16′) and (17′) differ by terms on [symbol] IR [symbol] in the right sides of them from Cr′, Cb′. The terms on [symbol] IR [symbol] represent variations (these are referred to as A) in color difference signals due to the difference between IR components in the original color signals expressed by the formula (6) and in the correction color signals expressed by the formula (12).

Since the R_{N}, B_{N} and Y_{N}, which form the right sides of the formulas (16) and (17), contain the IR component, they have large values compared with the R₀, B₀ and Y₀ by values corresponding to the IR component. As described above, as the IR component is increased, R₀, B₀ and Y₀ are decreased, and consequently levels of rounding errors contained in the R₀, B₀ and Y₀ forming the Cr₀ and Cb₀ may be relatively increased. On the contrary, since the R_{N}, B_{N} and Y_{N} have large values compared with the R₀, B₀ and Y₀, levels of rounding errors contained in the R_{N}, B_{N} and Y_{N} are relatively small. That is, in the color difference signals Cr_{N} and Cb_{N}, deviation in color balance due to the rounding errors hardly ever occurs.

Moreover, the digital signal processing circuit 8 can calculate the color difference signals Cr_{N} and Cb_{N} from the original color signals and the luminance signal corresponding to the color signals and the variation Δ in color difference signals, using the formulas (16′) and (17′). Again in this case, since levels of rounding errors in the [symbol] R [symbol] , [symbol] B [symbol] and Y′ contained in the right sides of the formulas (16′) and (17′) are relatively decreased, deviation in color balance hardly ever occurs.

The formulas (14), (16′) and (17′) in accordance with α, β and γ in the formula (13) can be expressed as follows. Here, λ and μ are assumed to have the above described values 0.713 and 0.564 respectively.
Y_{N}=Y₀+0.447κ [symbol] IR [symbol]
Cr_{N}=0.713( [symbol] R [symbol] −Y′)−0.105κ [symbol] IR [symbol]
Cb_{N}=0.564( [symbol] B [symbol] −Y′)−0.188κ [symbol] IR

[symbol]

The digital signal processing circuit 8 generates the luminance signal Y_{N} and the color difference signals Cr_{N} and Cb_{N} and outputs them. The Y_{N}, Cr_{N} and Cb_{N} are the luminance signal and the color difference signals in correspondence with the correction color signals R_{N}, G_{N} and B_{N}, and can express an image in which deviation in color balance is suppressed similarly as in the correction color signals.

Moreover, the digital signal processing circuit 8 can be configured in a manner of outputting the correction color signals R_{N}, G_{N} and B_{N}.

While a relation
Ir=Ig=Ib= [symbol] IR [symbol]
was assumed in the above configuration, in the case that each of the Ir, Ig and Ib as offset signal components is in a predefined relation with [symbol] IR [symbol] , the Ir, Ig and Ib can be determined by referring to the [symbol] IR [symbol] . Accordingly, if the relation of Ir, Ig and Ib to [symbol] IR [symbol] is previously obtained by a method such as measurement of spectral sensitivity characteristics of respective light receiving elements as shown in FIG. 1, correction color signals which are bright and suppressed in deviation in color balance, or a luminance signal and color difference signals corresponding to the correction color signals can be obtained by using the predefined relation in the same way as the above.

Moreover, the above method of making the offset signals contained in respective color signals into white light can be also applied to offset signal components in incident light other than those due to the IR component. Furthermore, a set of colors to which respective light receiving elements have specific sensitivity may be a set other than the set of R, G and B, and for example, may be the complementary color set of Cy, Mg and Ye.

As described above, the color signal processing method according to the invention is a method that uses a reference signal obtained from light receiving elements having certain reference spectral sensitivity characteristics, and several types of color signals obtained from several types of light receiving elements having spectral sensitivity characteristics, each of which is a synthesis of a specific sensitivity characteristic corresponding to each of specific colors different from one another and an offset sensitivity characteristic in accordance with the reference spectral sensitivity characteristic. In the method, furthermore, the color signal processing method according to the invention has a correction step of determining an offset signal component level in accordance with the offset sensitivity characteristic contained in each of the color signals based on the reference signal, and changing the ratio of the offset signal component levels among the several types of color signals, thereby generating each of correction color signals such as R_{N}, G_{N} and B_{N} as shown in the embodiment from each of the color signals. The ratio of the offset signal component levels among the correction color signals is determined according to the component ratio of each of the specific colors in white light.

Another color signal processing method according to the invention is also a method that uses a reference signal obtained from a light receiving element having a certain reference spectral sensitivity characteristic, and several types of color signals obtained from several types of light receiving elements having spectral sensitivity characteristics, each of which is a synthesis of a specific sensitivity characteristic corresponding to each of specific colors different from one another and an offset sensitivity characteristic in accordance with the reference spectral sensitivity characteristic. In the method, furthermore, a color signal processing method according to the invention has a correction color difference signal generation step of generating correction color difference signals in accordance with correction color signals from the several types of color signals. The correction color signal for each of the color signals has a changed ratio of the offset signal component level, corresponding to the offset sensitivity characteristic, among the color signal. The ratio of the offset signal component level among the correction color signals is determined according to a component ratio of each of the specific colors in white light. In the embodiment, an example of generating the correction color difference signals Cr_{N} and Cb_{N} according to the processing method was shown.

The correction color difference signal generation step can be configured to perform processing with a luminance signal generation step of generating a luminance signal in correspondence with the color signals, a step of obtaining the color difference signal variation amount based on the difference in the offset signal component levels of each of the color signals and each of the correction color signals, and a step of generating the correction color difference signal based on the color signals, the luminance signal, and the variation. The method of calculating the color difference signals Cr_{N} and Cb_{N} using the formulas (16′) and (17′) in the embodiment is an example of this configuration, and Y′ in the example corresponds to the luminance signal in correspondence with the color signals, and Δ corresponds to the variation in color difference signal respectively.

The color signal processing method according to the invention is particularly effective in the case that the reference spectral sensitivity characteristic has high sensitivity in an infrared light region compared with a visible light region.

In the embodiment, an example that the specific colors were three primary colors of red, green and blue was shown as another preferable aspect of the invention.

According to the invention described hereinbefore, correction color signal levels are increased by the size of offset signal components. That is, luminance that is larger than luminance only based on signal components in accordance with specific sensitivity characteristics of respective light receiving elements is obtained. On the other hand, the ratio of the offset signal component level among the correction color signals of respective specific colors is determined according to the component ratio of respective specific colors in white light. Thus, when respective specific color components expressed by respective correction color signals are synthesized, since white light is produced as a result of synthesizing the offset signal components, color balance is based on signal components corresponding to specific sensitivity characteristics of respective light receiving elements. That is, deviation in color balance due to the offset signal components is avoided.

What is claimed is:

1. A color signal processing method which uses a reference signal obtained from a light receiving element having a certain reference spectral sensitivity characteristic, and several types of color signals obtained from several types of light receiving elements having spectral sensitivity characteristics, each of which is a synthesis of a specific sensitivity characteristic corresponding to each of specific colors different from one another and an offset sensitivity characteristic in accordance with the reference spectral sensitivity characteristic, the method comprising,
a correction step of determining an offset signal component level in accordance with the offset sensitivity characteristic contained in each of the color signals based on the reference signal, and changing the ratio of the offset signal component levels among the color signals, thereby generating respective correction color signals from each of the color signals,
wherein the ratio of the offset signal component levels among the correction color signals is determined according to a component ratio of each of the specific colors in white light.

2. The color signal processing method according to claim 1,
wherein the reference spectral sensitivity characteristic has high sensitivity in an infrared light region compared with a visible light region.

3. The color signal processing method according to claim 1,
wherein the specific colors are three primary colors of red, green and blue.

4. A color signal processing method which uses a reference signal obtained from a light receiving element having a certain reference spectral sensitivity characteristic, and several types of color signals obtained from several types of light receiving elements having spectral sensitivity characteristics, each of which is a synthesis of a specific sensitivity characteristic corresponding to each of specific colors different from one another and an offset sensitivity characteristic in accordance with the reference spectral sensitivity characteristic, the method comprising,
a correction color difference signal generation step of generating correction color difference signals in accordance with correction color signals from the color signals,
wherein the correction color signals are generated by changing ratio of offset signal component levels in accordance with the offset sensitivity characteristics among the color signals, and
the ratio of the offset signal component levels among the correction color signals is determined according to the component ratio of each of the specific colors in white light.

5. The color signal processing method according to claim 4, wherein the correction color difference signal generation step has,
a luminance signal generation step for generating a luminance signal in accordance with the color signals,
a step for obtaining a color difference signal variation amount based on the difference in the offset signal component level between each of the color signals and each of the correction color signals, and
a step of generating the correction color difference signals based on the color signals, the luminance signal, and the variation amount.

6. The color signal processing method according to claim 4,
wherein the reference spectral sensitivity characteristic has high sensitivity in an infrared light region compared with a visible light region.

7. The color signal processing method according to claim 4,
wherein the specific colors are three primary colors of red, green and blue.
